(19) United States
(12) Patent Application Publication
(10) Pub. No.: US 2005/0174236 A1
(43) Pub. Date: Aug. 11, 2005

(54) RFID device tracking and information gathering

(76) Inventor: George M. Brookner, Norwalk, CT (US)

Correspondence Address: PERMAN & GREEN, 425 POST ROAD, FAIRFIELD, CT, 06824, US

(21) Appl. No.: 10/766,982

(22) Filed: Jan. 29, 2004

(51) Int. Cl. G08B 1/08

(52) U.S. Cl. 340/539.26; 340/870.01

(57) ABSTRACT

An RFID system includes an RFID transceiver, a sensor system, and an RFID interface connected to the sensor system for transmitting information acquired by the sensor system in response to interrogation by the RFID transceiver.

### BACKGROUND OF THE INVENTION

1. Field of the Invention

The present invention generally relates to products that rely on radio frequency identification (RFID) to impart information in response to an applied RF signal and, more particularly, to using RFID technology to track a product through its life cycle.

2. Brief Description of Related Developments

Radio Frequency Identity or Identification (RFID) is a means of storing and retrieving data through electromagnetic transmission to a RF compatible integrated circuit.

Read-only transponders store information that can be electronically read. The stored information can be, for example, a unique code. In some systems, a signal can be sent to a RFID tag, which charges the tag and allows the information stored in the tag to be returned.

RFID systems have several basic components or technical characteristics that define them. Referring to FIG. 1, generally, there are a transceiver 2, including an antenna 7 (the device that is used to read and/or write data to RFID tags), a tag 8 (a device that transmits the data to a reader) and the air interface 9 between them. RFID uses a defined radio frequency and protocol to transmit and receive data from tags. The transceiver 2 can be connected to a computer 4, which might also be connected to a database 6.

RFID tags are generally classified as active tags and passive tags, as defined by their power source.

Active tags include both a radio frequency transceiver and a battery to power the transceiver. Because there is a powered transceiver in the tag, active tags have substantially more range (approximately 300 feet or more) than passive or so called “active/passive tags.” Active tags are also, considerably more expensive than passive tags and, as with any battery-powered product, the batteries must be replaced periodically or the batteries must have sufficient capacity to support the product life cycle, or else the tracked product life cycle ends at the time the battery life ends.

Passive tags can be either battery or non-battery operated, as determined by the intended application. Passive tags reflect the RF signal transmitted to them from a reader or transceiver and add information by modulating the reflected signal. A passive tag does not use a battery to boost the energy of the reflected signal. A passive tag may use a battery to maintain memory in the tag or power the electronics that enable the tag to modulate the reflected signal. Battery-less (“pure passive” or “beam powered”) tags do not contain an internal power source such as a battery. These purely passive or “reflective” tags rely upon the electromagnetic energy radiated by an interrogator to power the. RF integrated circuit that makes up the tag itself.

There is a version of a passive tag that does contain a battery. This type of passive tag with a battery referred to as an “active/passive” tag has some of the attributes of a true active tag, but communicates in the same manner as a passive tag. An active/passive tag generally includes more complex integrated circuits with multiple components than a passive tag.

RF tags can also be distinguished by their memory type. Read/write memory, can be read as well as written into. Its data can be dynamically altered. Read only (typically “chipless”) type of tag memory is factory programmed and cannot be altered after the manufacturing process. Its data is static.

Tag 8 and transceiver 2 generally communicate by a wireless signal in a process known as coupling. Two methods of wireless signal coupling that may be used in RFID systems include close proximity electromagnetic or inductive coupling systems and propagating electromagnetic waves. Coupling is generally via antenna structures that form an integral feature of both tag 8 and transceiver 2.

Consumer and industrial devices and products are frequently manufactured and distributed to end users throughout the world. A particular supply chain distribution process may include a number of manufacturing processes and then transportation through the air, over water, and over land to an end user. Transport mechanisms may include airplanes, cargo ships, trucks, and rail transport. While in the supply chain, products or devices may be subject to a number of environmental conditions including for example, vibration, shock, temperature, humidity, barometric pressure, etc. While the products may be conveyed by various types of transport, and subjected to various environmental conditions, it is important that a product arrive at an end user's location without being subjected to undesirable conditions. After arrival at an end user's location it is important that the operating environment be maintained within the specifications for the particular product.

### SUMMARY OF THE INVENTION

The present invention presents a method and system for utilizing RFID technology to identify, track and acquire operational history of a product throughout its life cycle, from the time it is first manufactured until it is retired or scrapped.

It is an objective of this invention to employ RFID technology to monitor and record environmental changes experienced by a product throughout its life cycle. In one embodiment the product or packaging for the product may include sensors that report environmental conditions such as temperature, humidity and acceleration.

An imbedded RFID interface could receive data from the sensors related to environmental changes when those changes exceed pre-determined limits.

The present invention could provide a mechanism for remote data recovery without disrupting the product packaging. Rather the RFID interface may be scanned by an external RFID transceiver that, in turn, provides captured data from the tag to a back-end computing system and database where data analysis may take place.

In one embodiment, the present invention may provide the environmental data to various entities (i.e., an insurance company, shipper, government agency, manufacturer, etc.)to determine whether the product was handled properly or experienced situations beyond recommended limits, thus compromising performance or functionality.

In another embodiment of the present invention the back-end computing system may have the ability to organize, display, or print results of various analyses of the RFID acquired data supplied by the RFID transceiver.

It is another objective of this invention to provide the capability to remotely scan a device's RFID interface, particularly a product such as a postage meter, or other secure device, to acquire data about the device being scanned. Typical data may include date of manufacture, device product configuration/capabilities, expiration date, limitations of use, environmental conditions exposed to, etc.

It is still another objective of this invention to utilize public key encryption to provide security and authenticity for the information being gleaned from the RFID interface to prevent corruption or use by a potential fraudulent source or competitor. RFID interface may be uniquely identified using public key cryptography wherein each interface generates (or has securely injected) a public and private key pair and also utilizes a host back-end certificate. An interface may package responses to transceiver interrogations according to PKI standards of signing and encrypting. The back-end computing system may acknowledge a valid interface response by decoding the interface's host back-end certificate with its private key, thus authenticating the interface and may then authenticate the interface's signature and decrypt the response content.

It is yet another objective of this invention to utilize RFID interface responses to identify locations. A scanning service could remotely scan for RFID interfaces. The fact that each RFID interface is uniquely identified from all other RFID interfaces, allows the scanning service to collect and categorize RFID information including interface locations. With interface transmissions being encrypted, security of the data is assured. The scanning service could provide information to a customer via conventional means as reports, email, file transfer, or preferably by up-linking to the global positioning satellite system (GPS) to allow the customer to actively monitor the locations of their products. An advantage of this aspect of the invention would be to limit lost or stolen products, or locate lost or stolen products, and to assure that the products are at the location to which they are licensed.

It is still a further objective of this invention to incorporate into an RFID interface, the ability to format data in compliance with the USPS Information Based Indicia system wherein data output from the interface is formatted and signed in accordance with cryptographic standards (typically DSA, RSA, ECDSA) whereby the data output as presented to the back-end host can by formatted as a two dimensional barcode, capable of being scanned and authenticated as to the identity of the originating interface and the validity of that interfaces digital signature. Alternately the interface's output may be transmitted to a remote central source and mathematically authenticated, directly (i.e., no scan of hard copy required).

Thus, the present invention is directed to an RFID system including an RFID transceiver, a sensor system, and an RFID interface connected to the sensor system for transmitting information acquired by the sensor system in response to interrogation by the RFID transceiver. The RFID transceiver and RFID interface may exchange information in an encrypted format. The RFID interface may include a number of RFID interfaces, and the RFID transceiver is generally operable to distinguish among and exchange information with individual ones of the RFID interfaces. The system may include a back end host for analyzing information received by the RFID transceiver. The back end host may be operable to convey the information received by the RFID transceiver and the results of any analysis to another entity, and the information received by the RFID transceiver may includes position information from a position location service.

### BRIEF DESCRIPTION OF THE DRAWINGS

The foregoing aspects and other features of the present invention are explained in the following description, taken in connection with the accompanying drawings, wherein:

FIG. 1 is a block diagram of an RFID system.

FIG. 2 is a block diagram of an RFID system incorporating features of the present invention.

FIG. 3 is a block diagram of an RFID interface and sensor system according to the present invention.

FIG. 4 shows a diagram of a digital signature function and a Public Key digital signature function;

FIG. 5 shows a diagram of a signature verification function and a Public Key signature verification function;

FIG. 6 shows a system according to the invention communicating with various entities; and

FIG. 7 shows another embodiment of the present invention.

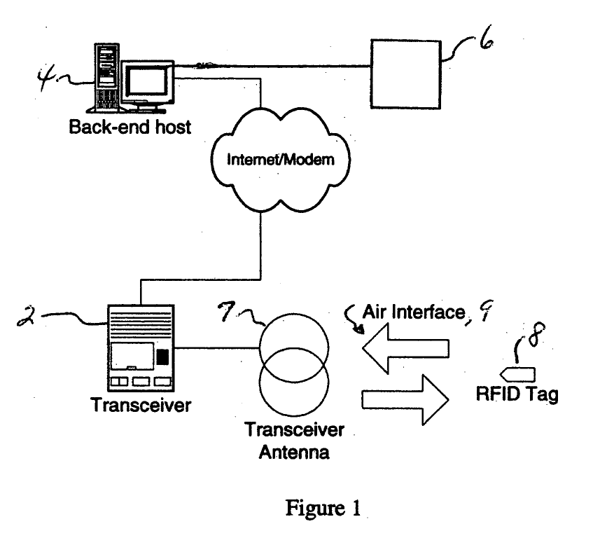

### DETAILED DESCRIPTION OF THE PREFERRED EMBODIMENTS

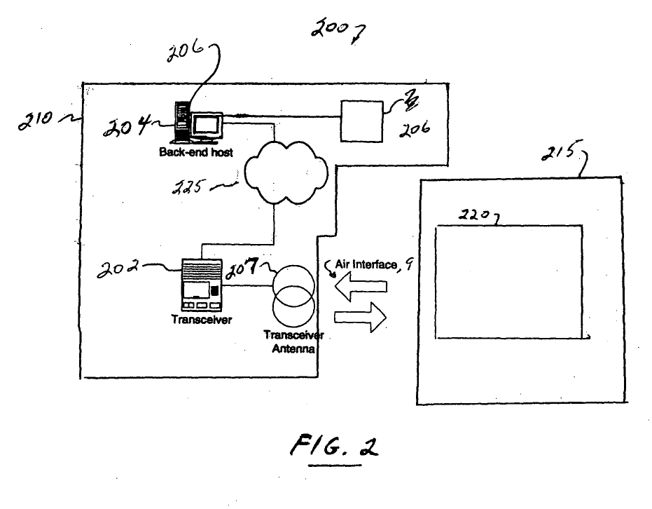

FIG. 2 illustrates a diagram of a system 200 incorporating features of the present invention. Although the present invention will be described with reference to the embodiment shown in the drawings, it should be understood that the present invention could be embodied in many alternate forms of embodiments. In addition, any suitable size, shape or type of elements or materials could be used.

System 200 using radio frequency identification (RFID) includes an interrogation function 210 and a response function 220 communicating through air interface 9. It is a feature of the present invention for interrogation function 210 to query response function 220 and receive information from response function 215 through air interface 9 using RFID techniques. Response function 220 is generally incorporated in a product 215 for use by an end user. The information conveyed may generally include product life cycle, environmental, and identification information.

Interrogation function 210 generally includes a back end host 204 and a database 206 connected to a transceiver 202. Transceiver 202 may be connected to back end host 204 and database 206 through a network 225 that may include any network suitable for communication, for example, the Internet, the Public Switched Telephone Network (PSTN), a wireless network, a wired network, a virtual private network (VPN) etc. Communication may be executed using any suitable protocol, including X.25, ATM, TCP/IP, etc. Transceiver 202 communicates with response functions 220 through air interface 9 using RFID techniques. As mentioned above, response function 220 may be incorporated into product 215.

Product 215 is generally a consumer or industrial product that is manufactured and conveyed to an end user through a distribution channel.

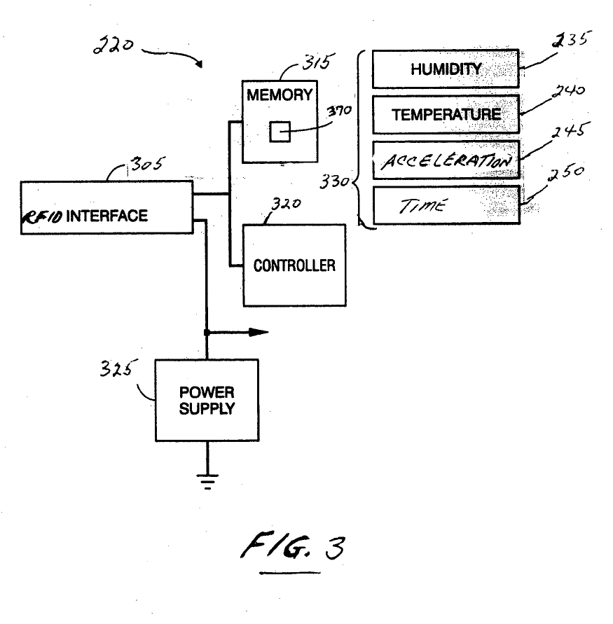

Response function 220 is shown schematically in FIG. 3 and may have a form factor that may be easily integrated within product 215 or its packaging. Response function 220 may include an RFID interface 305, a controller 320, memory 315, a power supply 325, and one or more sensors 330.

RFID interface 305 generally provides an interface between the circuitry in response function 220 and transceiver 202 (FIG. 2). RFID interface 305 may include an RFID tag, an RFID integrated circuit or any other circuitry or software suitable for communicating with transceiver 202 using RFID techniques.

Controller 320 may include logic circuitry for generally controlling the operation of response function 220, and may operate in conjunction with memory 315. For example, control circuitry 320 may include a processor that operates programs found in memory 315.

Memory 315 may provide storage for measurements acquired by the one or more sensors 330. Memory 315 may be configured as a non-volatile memory which retains its contents in the event of a power loss. Memory 315 may also include status data about product 215. Status data may include a product serial number, date of manufacture, device configuration/capabilities, expiration date, limitations of use, etc.

Programs 370 that may be accessed by controller 320 for controlling response function 220 may also be stored in memory 315. Programs 370 may include instructions for operating RFID interface 305 and sensors 330. Programs 370 may also include instructions for utilize public key encryption methods to provide security and authenticity for the information transmitted from RFID interface 305.

Power supply 325 may be any suitable power source for supplying power to response function 220. In another embodiment power supply 325 may be a conventional power supply or a battery power supply provided as part of product 215 (FIG. 2).

The one or more sensors 330 may include sensors for detecting various types of environmental conditions. More particularly, sensors 330 may include, for example, a humidity sensor 235, a temperature sensor 240, an acceleration sensor 245, and a timer 250. Each of the one or more sensors 330 may include suitable support circuitry, for example, amplifiers, filters, and converters, and may be capable of providing an analog output or a digital output as required. Each of the sensors 330 may be connected individually or via a bus to other circuitry, and may also be capable of generating an interrupt, alarm, or some other type of alert in the event that one or more particular conditions exist, or that any number of thresholds have been exceeded or have not been met. One or more of the sensors 330 may include a “sample and hold” capability where a particular measurement may be latched or otherwise held until read from the particular sensor.

Humidity sensor 235 may be a capacitive humidity sensor with appropriate support circuitry, an analog output humidity module, or a digital output humidity module. In one embodiment, humidity sensor is capable of sensing a range of from about 0% to about 100% relative-humidity.

Temperature sensor 240 may be a thermistor, thermocouple, or a resistance temperature device (RTD) with suitable support circuitry. Temperature sensor 240 may be capable of measuring a temperature in the range of from about −55 to about +125 degrees C., and may provide an analog or digital output.

Acceleration sensor 245 may be multi-axial, that is, it may be capable of measuring acceleration in two or three orthogonal directions simultaneously, and may be capable of measuring a range of acceleration from about 0 to 100 g's.

Timer 250 may be capable of measuring elapsed time or particular time periods. Timer 250 may be a programmable device capable of starting or stopping upon receiving a trigger and of generating a signal upon the expiration of a particular period. Timer 250 may be triggered by one or more sensors 330. For example, timer 250 may be used to measure an amount of time spent at a particular humidity level, or an amount of time spent below a particular temperature threshold.

Once response function 220 has been initialized and set up, controller 320 may begin acquiring and storing data from sensors 330. In response to interrogation by transceiver 2, controller 320 will generally format and encrypt data using a response function private key and a data signature before transmitting the data to transceiver 202. Upon reception by transceiver 202, the data is then conveyed to back end host 204 through network 225. Back end host 204 includes programs 206 for performing decryption and signature verification functions.

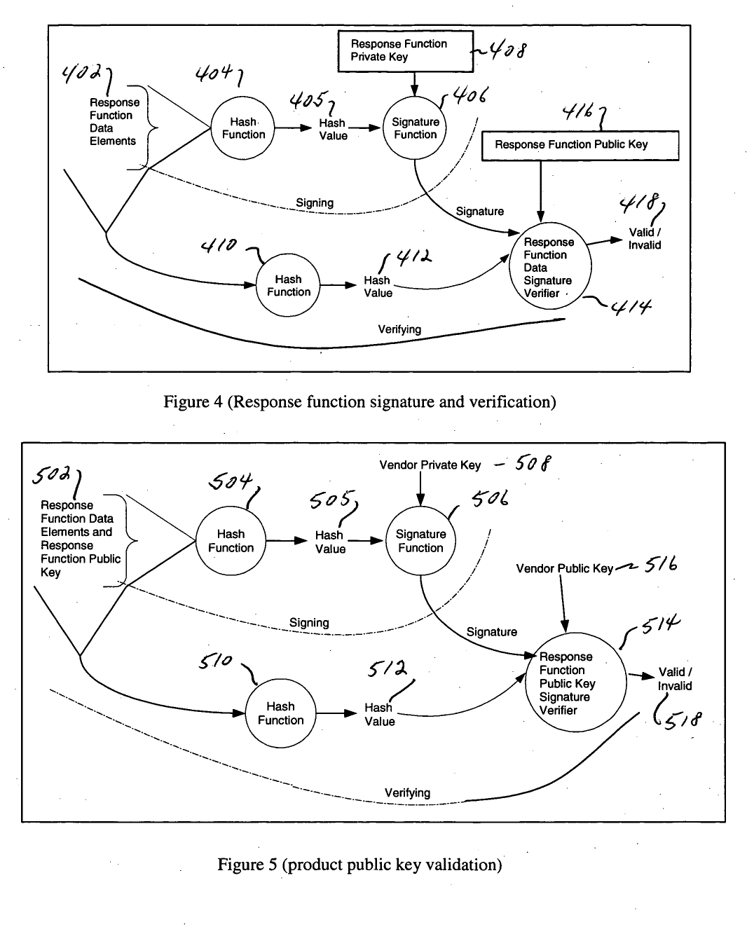

FIG. 4 illustrates one embodiment of a validation process for data signatures of response functions. Response function data to be transmitted, also referred to as response function data elements 402 are applied to a hash function 404 to result in a hash value 405. The hash value 405 and a private key 408 specific to the response function 220 are combined to produce the signature function 406. During verification, the hash value 412, produced from the hash function 410 as applied to the response data elements 402, is input to the response function data signature verifier 414, together with the signature and the response function public key 416. The result 418 determines the validity or invalidity of the response function data elements 402 after transmission.

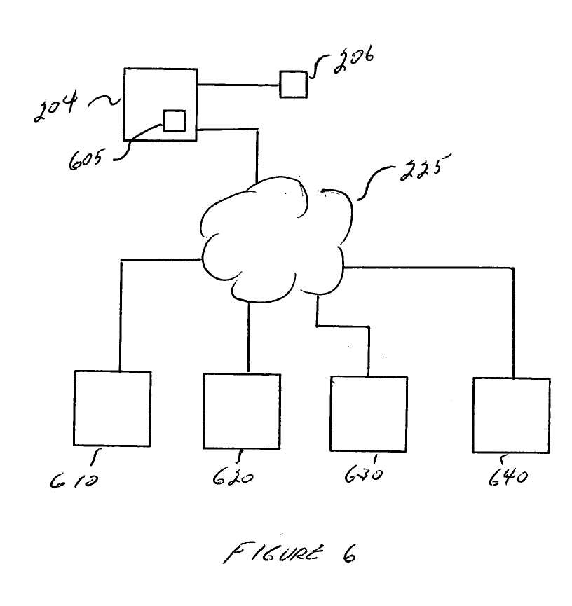

FIG. 5 illustrates the validation of the key used by the signature function 506. The response function data elements and the response function public key 502 are hashed via a hash function 504 to produce a hash value 505. The hash value 505 and a private key 508 specific to a vendor of the product 215 are used to produce the signature function 506. A public key 516 specific to the vendor of the product 215 is used together with the signature function key 506 and hash value in the response function public key signature verifier 514 to determine if the response function data elements are signed by the proper authority and are determined to be valid or invalid 518.

RFID interface 305 may also have the ability to format the transmitted data 402 in compliance with the USPS Information Based Indicia system wherein transmitted data 480 is formatted and signed in accordance with cryptographic standards (typically DSA, RSA, ECDSA) whereby the transmitted data 402 may be presented to back-end host 204 formatted as a two dimensional barcode, capable of being scanned and authenticated as to the identity of the originating RFID interface and the validity of that RFID interface's digital signature. Alternately the RFID interface's transmitted data 402 may be transmitted to a remote central source and mathematically authenticated directly without scanning any hardcopy.

Examples of the operation of the system 200 will now be described with reference to FIGS. 2 and 3.

Upon power up, controller 320 may initialize itself and cause the components of response function 220 to initialize. Programs 370 may then cause controller 320 to determine the presence type and capabilities of sensors 330 and set thresholds and alert parameters as appropriate for measuring particular conditions to which product 215 may be subjected. Individual ones of sensors 330 may also set up to generate interrupts upon reaching or failing to reach certain thresholds or generally upon measuring certain conditions.

After completing the above mentioned initialization and setup procedures, controller 320 may then enter a “wait” mode where it simply waits for an interrupt from one of the sensors 330. Upon receiving an interrupt, controller 320 may operate to examine the interrupt and identify a service routine to be performed. For example, an interrupt may be serviced by reading the current humidity from humidity sensor 235 or the current temperature from temperature sensor 240. A date and time stamp may then be generated from the time value and associated with the temperature or humidity measurements and then the measurements and associated time and date stamp may be stored in memory 315.

As another example, acceleration sensor 245 may be programmed to generate an interrupt upon exceeding a particular acceleration value, for example, 5 g's. Upon exceeding that threshold, an interrupt is generated, controller 320 identifies the type of interrupt service routine required and reads the acceleration value. The value may then be stored in memory 315 with a time stamp.

In another embodiment, Controller 320 may simply poll each sensor 330 on a periodic basis, collect information and store the sensor information in memory 315.

The contents of memory 315 may be retained until response function 220 is interrogated by transceiver 202. When desired, the contents of memory 315 may be read in accordance with the encryption and certificate techniques described above and used to analyze the conditions to which product 215 has been subjected or its status. Referring to FIGS. 2 and 3 interrogation occurs by bringing transceiver antennas 207 within communicating distance with RFID interface 305. This may be done without opening product 215 or its packaging, and may be done anywhere or anytime during the manufacture or life cycle of product 215.

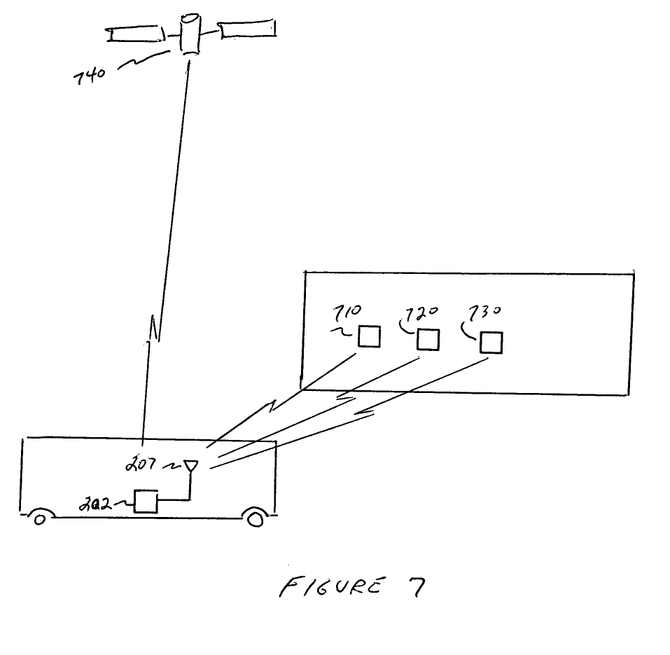

For example, upon arrival at a destination, transceiver antenna 207 may be brought within communicating distance of RFID interface 305 and data may be communicated using the encryption and certification techniques described above. Once the data has been extracted, back end host may analyze the data and determine the status of product 215 and may also determine the environmental conditions to which product 215 has been subjected. Referring to FIG. 6, the status and environmental conditions 605 may be communicated to various entities 610 . . . 640, which may include a shipper 610, an insturance company 620, a government agency 630, the manufacturer, or any other entity that may utilize such data 605. The status and environmental conditions 605 may be communicated through network 225, for example by file transfer, e-mail, etc. or by using any other communication such as mail, facsimile, etc.

Referring to FIG. 7, transceiver antenna 207 may be brought within communicating distance in any number of ways. For example, a scanning service may broadcast an RFID interrogation signal to which one or more RFID interfaces 710, 720, 730 may respond. The scanning service may broadcast the RFID interrogation signal and receive RFID responses using a mobile device, for example a hand held or vehicle mounted mobile device.

In another aspect of the invention, the transceiver 202 may utilize positioning information to determine an approximate location of response function 220 and thus product 215. For example upon establishing communication with a RFID interface, transceiver 202 may also establish communication with a position or location service 740 such as the Global Positioning System (GPS). Upon receiving location coordinates from the position service 740 the transceiver may include position data with the information sent to back end host 204. Location information may be used to actively monitor the location of product 215, locate it if stolen or lost and to assure that product 215 is at a location to which is licensed.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

1. An RFID system comprising:
an RFID transceiver;
a sensor system; and
an RFID interface connected to the sensor system for transmitting information acquired by the sensor system in response to interrogation by the RFID transceiver.

2. The system of claim 1, wherein the RFID transceiver and RFID interface exchange information in an encrypted format.

3. The system of claim 1, wherein the RFID interface comprises a plurality of RFID interfaces, and the RFID transceiver is operable to distinguish among and exchange information with individual ones of the plurality of RFID interfaces.

4. The system of claim 1, further comprising a back end host for analyzing information received by the RFID transceiver.

5. The system of claim 4, wherein the back end host is operable to convey the information received by the RFID transceiver and the results of any analysis to another entity.

6. The system of claim 5, wherein the information received by the RFID transceiver includes position information from a position location service.

7. A method of exchanging information comprising:
interrogating an RFID interface; and
transmitting environmental data collected by sensors through the RFID interface in response to the interrogation;

8. The method of claim 7, further comprising transmitting the environmental data in an encrypted format.

9. The method of claim 7, further comprising:
interrogating a plurality of RFID interfaces; and
distinguishing among and exchanging information with individual ones of the plurality of RFID interfaces.

10. The method of claim 7, further comprising analyzing information received by the RFID transceiver.

11. The method of claim 10, further comprising conveying the information received by the RFID transceiver and the results of any analysis to another entity.

12. The method of claim 11, wherein the information received by the RFID transceiver includes position information from a position location service.
